(19) United States
(12) Patent Application Publication
(10) Pub. No.: US 2017/0066682 A1
(43) Pub. Date: Mar. 9, 2017

(54) ALKALI-FREE FLOAT SHEET GLASS, AND METHOD FOR PRODUCING ALKALI-FREE FLOAT SHEET GLASS

(71) Applicant: ASAHI GLASS COMPANY, LIMITED, Chiyoda-ku (JP)

(72) Inventors: Shiro TANII, Tokyo (JP); Kazutaka ONO, Tokyo (JP); Hirofumi TOKUNAGA, Tokyo (JP); Yosuke INAI, Tokyo (JP); Daisuke KOBAYASHI, Tokyo (JP)

(73) Assignee: ASAHI GLASS COMPANY, LIMITED, Chiyoda-ku (JP)

(21) Appl. No.: 15/357,262

(22) Filed: Nov. 21, 2016

Related U.S. Application Data
(63) Continuation of application No. PCT/JP2015/064540, filed on May 20, 2015.

(30) Foreign Application Priority Data
May 21, 2014 (JP) 2014-105192

(51) Int. Cl. C03C 3/118; C03B 18/02

(52) U.S. Cl. CPC C03C 3/118; C03B 18/02

(57) ABSTRACT

The present invention relates to an alkali-free float sheet glass having a glass transition point of from 730 to 850° C. and a temperature T₄ of from 1220 to 1350° C., and containing, indicated by mass % on the basis of oxides: SiO₂: 57 to 65%, Al₂O₃: 14 to 23%, B₂O₃: 0 to 5.5%, MgO: 1 to 8.5%, CaO: 3 to 12%, SrO: 0 to 10%, and BaO: 0 to 5%, satisfying MgO+CaO+SrO+BaO of from 12 to 23%, containing F in an amount of from 0.1 to 0.35 mass %, containing Cu in an amount of from 0.3 to 3 mass ppm, containing Cl in an amount of from 0 to 0.05 mass %, and satisfying a ratio f₁/f₂ of from 0.05 to 0.5.

### TECHNICAL FIELD

The present invention relates to an alkali-free float sheet glass containing substantially no alkali metal oxide, and a method for producing an alkali-free float sheet glass.

### BACKGROUND ART

A float process is widely used as a method for forming a sheet glass. In the float process, a glass melt continuously fed onto a tin melt in a float bath (hereinafter sometimes simply referred to as a “bath”) is fluidized on the tin melt to form a band plate shape (for example, see Patent Document 1). Atmosphere in the bath is made a reducing atmosphere containing hydrogen gas in order to prevent oxidation of the tin melt. The hydrogen gas reacts with oxygen gas intruding from the outside, thereby preventing oxidation of the tin melt.

### PRIOR ART DOCUMENTS

### Patent Document

Patent Document 1: JP-A-2010-53032

### SUMMARY OF THE INVENTION

### Problems that the Invention is to Solve

When a glass melt is shaped in a bath, there was the case that particles in a reducing atmosphere aggregate, drop on an upper surface of the glass melt, and adhere thereto, thereby causing a defect on a top surface of a float sheet glass produced. The top surface indicates a surface opposite a surface (bottom surface) at which a glass ribbon is brought into contact with a tin melt when the float glass is formed by the floating process.

With expansion of the use of a sheet glass from the conventional field of building materials to a field of electronic materials, the defect of a top surface of a float sheet glass has further become a problem. For example, in the case of a sheet glass for various displays, if a defect of visible size is found out on a top surface of a float sheet glass, the part containing the defect on a top surface of a float sheet glass is disposed of as a defective material.

In the case where a sheet glass for various displays, particularly, one in which a metal or oxide thin film or the like is formed on the surface thereof, contains an alkali metal oxide, an alkali metal ion diffuses in a thin film to deteriorate film properties. Therefore, it is required to be an alkali-free sheet glass containing substantially no alkali metal ion.

The present invention has been made in view of the above problems, and has an object to provide an alkali-free float sheet glass in which a defect on a top surface is suppressed, and a method for producing an alkali-free float sheet glass.

### Means for Solving the Problems

In order to solve the above object, according to one aspect of the present invention, there is provided an alkali-free float sheet glass having a glass transition point of from 730 to 850° C. and a temperature T₄ at which viscosity reaches 10⁴ poises of from 1220 to 1350° C., and containing, indicated by mass % on the basis of oxides:

SiO₂: 57 to 65%,

Al₂O₃: 14 to 23%,

B₂O₃: 0 to 5.5%,

MgO: 1 to 8.5%,

CaO: 3 to 12%,

SrO: 0 to 10%, and

BaO: 0 to 5%,

satisfying MgO+CaO+SrO+BaO of from 12 to 23%,

containing F in an amount of from 0.1 to 0.35 mass %, containing Cu in an amount of from 0.3 to 3 mass ppm, containing Cl in an amount of from 0 to 0.05 mass %, and satisfying a ratio f₁/f₂ of from 0.05 to 0.5 between F amount f₁ at a depth of 1 μm from a top surface of a float sheet glass and F amount f₂ at a depth of 13 μm from the top surface of the float sheet glass.

According to another aspect of the present invention, there is provided a method for producing an alkali-free float sheet glass, in which the alkali-free float sheet glass containing, indicated by mass % on the basis of oxides, the following components, F in an amount of from 0.1 to 0.35 mass %, Cu in an amount of from 0.3 to 3 mass ppm and Cl in an amount of from 0 to 0.05 mass %, and having a glass transition point of from 730 to 850° C. and a temperature T₄ at which viscosity η reaches 10⁴ poises of from 1220 to 1350° C., the method containing steps of preparing a glass raw material such that F content is from 0.15 to 1.0 mass %, Cu content is from 0.4 to 6 mass ppm and Cl content is 0.15 mass % or less in the glass raw material, introducing the glass raw material into a melting furnace to melt, and clarifying to obtain a molten glass,

SiO₂: 57 to 65%,

Al₂O₃: 14 to 23%,

B₂O₃: 0 to 5.5%,

MgO: 1 to 8.5%,

CaO: 3 to 12%,

SrO: 0 to 10%,

BaO: 0 to 5%, and

MgO+CaO+SrO+BaO: 12 to 23%.

### Advantageous Effects of the Invention

According to the present invention, an alkali-free float sheet in which a defect on a top surface has been suppressed can be obtained.

### BRIEF DESCRIPTION OF THE DRAWINGS

FIG. 1 is a view showing a profile of F amount in a depth direction from a top surface of a float sheet glass.

FIG. 2 is a view showing a profile of Cu amount in a depth direction from a top surface of a float sheet glass.

FIG. 3 is a view showing a profile of Cl amount in a depth direction from a top surface of a float sheet glass.

### MODE FOR CARRYING OUT THE INVENTION

The composition range of respective components is described. In the followings, unless particularly otherwise indicated, “%” indicates “mass %”.

In the case where SiO₂ is less than 57%, a glass transition point and a stain point are not sufficiently increased, and additionally an average thermal expansion coefficient is increased and a density is increased. The SiO₂ amount is preferably 58% or more, and more preferably 59% or more.

On the other hand, in the case where the SiO₂ amount exceeds 65%, meltability is deteriorated. The SiO₂ amount is preferably 64% or less, more preferably 63% or less, and still more preferably 62% or less.

Al₂O₃ suppresses phase separation property of glass, decreases a thermal expansion coefficient, and increases a glass transition point and a strain point. However, in the case of less than 14%, those effects are not exhibited, and other component for increasing expansion is increased, resulting in the increase of thermal expansion. The Al₂O₃ amount is preferably 15% or more, more preferably 16% or more, and still more preferably 17% or more.

On the other hand, in the case where the Al₂O₃ amount exceeds 23%, meltability of glass is deteriorated. The Al₂O₃ amount is preferably 22% or less, and more preferably 21% or less.

B₂O₃ is not essential, but can be contained in order to improve melt reactivity of glass. The B₂O₃ amount is preferably 0.5% or more, more preferably 1% or more, and still more preferably 1.5% or more.

However, in the case where the B₂O₃ amount is too large, a glass transition point and a strain point are decreased. Therefore, the B₂O₃ amount is made 5.5% or less. The B₂O₃ amount is preferably 5% or less, more preferably 4% or less, and still more preferably 3% or less.

Of alkali earth, MgO has the characteristics that it does not increase expansion and does not excessively decrease a glass transition point and a strain point, and also improves meltability. In the case where the MgO amount is less than 1%, the above-described effects by the addition of MgO are not sufficiently exhibited. The MgO amount is preferably 2% or more, more preferably 3% or more, and still more preferably 4% or more.

However, in the case where the MgO amount exceeds 8.5%, there is a concern that a devitrification temperature is increased. The MgO amount is preferably 8% or less, more preferably 7% or less, and still more preferably 6% or less.

Of alkali earth, CaO has the characteristics that it does not increase expansion, next to MgO, and does not excessively decrease a glass transition point and a strain point, and also improves meltability. In the case where the CaO amount is less than 3%, the above-described effects by the addition of CaO are not sufficiently exhibited. The CaO amount is preferably 4% or more, more preferably 5% or more, and still more preferably 6% or more.

However, in the case where the CaO amount exceeds 12%, compaction is increased, and a devitrification temperature is increased. The CaO amount is preferably 11% or less, more preferably 10% or less, and still more preferably 9% or less.

SrO is not essential, but can be contained because it improves meltability without increasing a devitrification temperature of glass. The SrO amount is preferably 0.1% or more, more preferably 0.5% or more, and still more preferably 1% or more.

However, in the case where it is too much, there is a concern that an expansion coefficient is increased. Therefore, the SrO amount is made 10% or less. The SrO amount is preferably 9% or less, more preferably 8% or less, and still more preferably 7% or less.

BaO is not essential, but can be contained because it improves meltability without increasing a devitrification temperature of glass, similar to SrO. The BaO amount is preferably 0.1% or more, more preferably 0.5% or more, and still more preferably 1% or more.

However, in the case where it is too much, expansion and density of glass are excessively increased. Therefore, the BaO amount is made 5% or less. The BaO amount is preferably 4.5% or less, more preferably 4% or less, and still more preferably 3.5% or less.

In the case of considering environmental load, it is preferred that BaO is not substantially contained.

SnO₂ is not an essential component, but is a component that improves clearness during the production of glass. SnO₂ generates O₂ gas in a glass melt obtained by melting a glass raw material. In the glass melt, SnO₂ has the functions that it is reduced to SnO at a temperature of 1450° C. or higher to generate O₂ gas, and grows bubbles bigger. In order to further effectively enlarge bubbles, a glass raw material is melted at preferably 1500° C. or higher. It is preferred that the Sn content in glass is 0.01% or more in terms of SnO₂ (i.e., as SnO₂ content). In the case where SnO₂ is less than 0.01%, clarification effect when melting glass is not obtained. The SnO₂ content is preferably 0.02% or more, more preferably 0.05% or more, and still more preferably 0.1% or more.

In the case where SnO₂ exceeds 1%, there is a concern that coloration and devitrification of glass occur. Therefore, it is preferred that the Sn content in glass is 1% or less in terms of SnO₂. The SnO₂ content is more preferably 0.8% or less, still more preferably 0.6% or less, still further preferably 0.4% or less, and particularly preferably 0.3% or less.

In the case where the total content of MgO, CaO, SrO, and BaO (MgO+CaO+SrO+BaO) is smaller than 12%, meltability is poor. The total content is preferably 13% or more, more preferably 14% or more, still more preferably 14.5% or more, and particularly preferably 15% or more.

On the other hand, in the case where the total content is larger than 23%, there is a concern that the disadvantage that a thermal expansion coefficient cannot be decreased occurs. The total content is preferably 22% or less, more preferably 21% or less, and still more preferably 20% or less.

F is contained for the purpose of preventing a defect on a top surface of a float sheet glass produced.

The present inventors suppose the mechanism that a defect is generated on a top of a float sheet glass produced, as follows.

In a bath, a part of Sn volatilizes from a surface of a tin melt. Furthermore, in the case where a glass composition contains SnO₂, a part of Sn also volatilizes from a surface of a glass ribbon in the state of a glass melt.

The glass of the present invention contains Cu as an unavoidable impurity. For this reason, a part of Cu volatilizes from the surface of the glass melt in the bath.

Cu and Sn volatilized form an intermetallic compound, the intermetallic compound becomes a nucleus, and Sn in the atmosphere in the bath aggregates. The Sn aggregated drops on an upper surface of the glass melt, adheres thereto, and becomes a defect on a top surface of a float sheet glass produced.

The present invention is particularly effective to suppress a defect on the top surface in the case where a glass composition contains SnO₂.

Regarding the mechanism that the above-mentioned intermetallic compound becomes a nucleus and Sn in the atmosphere in a bath aggregates, the present inventors suppose as follows.

When Cu and Sn form the intermetallic compound, a vapor pressure of an atmosphere in which the intermetallic compound is present is decreased. In order to complement the decrease of the vapor pressure, Sn vapor present around is attracted, thereby aggregation growth of Sn occurs.

On the other hand, in the present invention, a part of F volatilizes as F₂ from a surface of a glass melt in a bath. F₂ volatilized reacts with Sn in the atmosphere to form SnF₂. SnF₂ is stably present in the atmosphere, and therefore prevents that Cu and Sn form an intermetallic compound. Accordingly, aggregation of Sn as an intermetallic compound of Cu and Sn being a nucleus is prevented. As a result, it is prevented that Sn aggregated drops on an upper surface of a glass melt, adheres thereto and becomes a defect on a top surface of a float sheet glass produced.

In the case where the F content is 0.1% or less, the above-described effect by the addition of F is not sufficiently exhibited. The F content is preferably 0.13% or more, more preferably 0.15% or more, and still more preferably 0.17% or more.

However, in the case where the F content exceeds 0.35%, a glass transition point and a strain point tend to be decreased. The Fe content is preferably 0.3% or less, more preferably 0.25% or less, and still more preferably 0.23% or less.

However, in the case where the Cl content in glass is high, the above-described effect by the addition of F is inhibited, and there is a concern that a defect is generated on a top surface of a float sheet glass produced.

Regarding the reason that the above-described effect by the addition of F is inhibited in the case where the Cl content in the glass is high, the present inventors suppose as follows.

A part of Cl volatilizes as Cl₂ from a surface of a glass melt in a bath. Cl₂ volatilized reacts with Sn in the atmosphere to form SnCl₂. Reactivity of Cl to Sn is higher than that of F. Therefore, the reaction between Sn and Cl preferentially occurs, and the reaction between Sn and F is inhibited.

The temperature of the atmosphere in the bath is from 700 to 1250° C., and particularly the temperature at the upstream side is from 900 to 1250° C. In this temperature region, stability of SnCl₂ is lower than SnF₂. Therefore, it tends to dissociate into Sn and Cl₂. Sn dissociated forms an intermetallic compound with Cu. The intermetallic compound becomes a nucleus, and Sn in the atmosphere in the bath aggregates.

In the case where the Cl content exceeds 0.05%, the effect by the addition of F is inhibited by the above-described action. For this reason, the Cl content is made 0.05% or less. The Cl content is preferably 0.02% or less, more preferably 0.015% or less, and still more preferably 0.013% or less.

There is a case that Cl is contained in the glass of the present invention for the purpose of improving clearness during the production of glass. In this case, the Cl content is preferably 0.003% or more, more preferably 0.005% or more, and still more preferably 0.007% or more.

As described above, the glass of the present invention contains Cu as an unavoidable impurity. The Cu content is from 0.3 to 3 mass ppm, preferably from 0.4 to 2 mass ppm, more preferably from 0.4 to 1.5 mass ppm, and still more preferably from 0.5 to 1.3 mass ppm.

As described above, a part of F volatilizes from a surface of a glass melt in a bath in the production process of the float sheet glass of the present invention. Therefore, the float sheet glass produced is that the F amount in the vicinity of the top surface is lower than the F amount in the inside of the float sheet glass. Specifically, when the F amount at a depth of 1 μm from the top surface of the float sheet glass is taken as f₁ and the F amount at a depth of 13 μm from the top surface of the float sheet glass is taken as f₂, a ratio f₁/f₂ between f₁ and f₂ is from 0.05 to 0.5.

In the present description, the f₁ is an average value of the F amount in a region at a depth of from 0.9 to 1.1 μm from the top surface of the float sheet glass. The f₂ is an average value of the F amount in a region at a depth of from 12.9 to 13.1 μm from the top surface of the float sheet glass, and is substantially the same amount as the F amount in the inside of the float sheet glass.

The f₁ and f₂ can be obtained by obtaining a profile of F amount in a depth direction from a top surface of glass by using a secondary ion mass spectrometry (SIMS). SIMS analysis conditions are as follows.

Equipment: IMS-7f manufactured by AMETEK

Primary ion species: Cs⁺

Accelerated voltage of primary ion: 15 kV

Detection region: 30 μm diameter

Polarity of secondary ion: Negative

Monitor secondary ion: ¹⁹F, ²⁸Si (or ³⁰Si)

Neutralization method: By Pt coating and electron beam irradiation to sample surface

Reference sample for quantitative determination of concentration: One in which ¹⁹F has been ion-injected in thermal oxide film (SiO₂ film) on Si wafer.

The f₁/f₂ is preferably from 0.1 to 0.44, more preferably from 0.14 to 0.42, still more preferably from 0.2 to 0.4, and particularly preferably from 0.25 to 0.38.

As described above, a part of Cu volatilizes from a surface of a glass melt in a bath in the production process of the float sheet glass of the present invention. Therefore, the float sheet glass produced is that the Cu amount in the vicinity of the top surface is lower than the Cu amount in the inside of the float sheet glass. Specifically, when the Cu amount at a depth of 0.5 μM from the top surface of the float sheet glass is taken as cu₁ and the Cu amount at a depth of 8 μm from the top surface of the float sheet glass is taken as cu₂, a ratio cu₁/cu₂ between cu₁ and cu₂ is from 0.05 to 0.7.

In the present description, the cu₁ is an average value of the Cu amount in a region at a depth of from 0.4 to 0.6 μm from the top surface of the float sheet glass. The cu₂ is an average value of the Cu amount in a region at a depth of from 7.9 to 8.1 μm from the top surface of the float sheet glass, and is substantially the same amount as the Cu amount in the inside of the float sheet glass.

Similar to the f₁ and f₂, the cu₁ and cu₂ can be obtained by obtaining a profile of Cu amount in a depth direction from the top surface of glass by SIMS method. In the measurement of Cu, ⁶³Cu and ²⁸Si (or ³⁰Si) are chosen as monitor secondary ions and one in which ⁶³Cu has been ion-injected in a thermal oxide film (SiO₂ film) on an Si wafer is used as a reference sample for quantitative determination.

The cu₁/cu₂ is preferably from 0.1 to 0.6, more preferably from 0.15 to 0.55, still more preferably from 0.2 to 0.5, and particularly preferably from 0.25 to 0.45.

As described above, in the production process of the float sheet glass of the present invention, a part of Cl volatilizes from a surface of a glass melt in a bath. Therefore, the float sheet glass produced is that the Cl amount in the vicinity of the top surface thereof is lower than the Cl amount in the inside of the float sheet glass. Specifically, when the Cl amount at a depth of 1 μm from the top surface of the float sheet glass is taken as cl₁ and the Cl amount at a depth of 13 μm from the top surface of the float sheet glass is taken as cl₂, a ratio cl₁/cl₂ between cl₁ and cl₂ is from 0.05 to 0.85.

In the present description, the cl₁ is an average value of the Cl amount in the region of a depth of from 0.9 to 1.1 μm from the top surface of the float sheet glass. The cl₂ is an average value of the Cl amount in the region of a depth of from 12.9 to 13.1 μm from the top surface of the float sheet glass, and is substantially the same amount as the Cl amount in the inside of the float sheet glass.

Similar to the f₁ and f₂, the cl₁ and cl₂ can be obtained by obtaining a profile of Cl amount in a depth direction from a top surface of glass. In the measurement of Cl, ³⁵Cl and ²⁸Si (or ³⁰Si) are chosen as monitor secondary ions and one in which ³⁵Cl has been ion-injected in a thermal oxide film (SiO₂ film) on an Si wafer is used as a reference sample for quantitative determination.

The cl₁/cl₂ is preferably from 0.1 to 0.8, more preferably from 0.2 to 0.75, still more preferably from 0.3 to 0.7, and particularly preferably from 0.35 to 0.65.

The float sheet glass of the present invention has a glass transition point of from 730 to 850° C., and therefore, thermal shrinkage during the production of a panel can be suppressed. Furthermore, a solid phase crystallization method can be applied as a production method of p-Si TFT.

The float sheet glass of the present invention has a glass transition point of from 730 to 850° C., and therefore is suitable for uses of high glass transition point and high strain point (e.g., a display substrate or lighting substrate for an organic EL, or a display substrate or lighting substrate of a thin film having a thickness of 100 μm or less). However, in the case where the glass transition point is too high, there is a concern that a defect is easy to be generated during float forming of glass. For this reason, the glass transition point is preferably from 740 to 840° C., more preferably from 750 to 820° C., and still more preferably from 760 to 800° C.

The float sheet glass of the present invention has a temperature T₄ at which a viscosity η reaches 10⁴ poises of from 1220 to 1350° C. The T₄ is a temperature becoming a rough indication of float formability. In the case where the T₄ is from 1220 to 1350° C., it is preferred in forming glass by a float process.

The T₄ is preferably 1330° C. or lower, more preferably 1310° C. or lower, and still more preferably 1300° C. or lower.

Next, a method for producing a float sheet glass is described.

The method for producing a float sheet glass by the present embodiment contains a melting step, a clarification step, a forming step, an annealing step, and a cutting step, and as necessary, further includes a polishing step. The polishing step is performed depending on the use of a glass plate.

In the melting step, several kinds of glass raw materials are blended, the glass raw materials are introduced in a melting furnace to melt, to thereby obtain a molten glass. The glass raw materials, after introduced in the melting furnace, are melted by radiant heat of flame injected from a burner, to form a molten glass.

The clarification step is a step of removing bubbles in the molten glass. In order to effectively remove bubbles, F, Cl, SnO₂, SO₃, Fe₂O₃ and the like are used as a clarifier in the production of an alkali-free float sheet glass. F and Cl are components that generate a large amount of bubbles when applying heat to raw materials and enlarge the bubbles. By using those together with SO₃ and Fe₂O₃, clarification effect is remarkably improved. Those can be generally added as a fluoride or chloride of an alkaline earth.

In the forming step, a molten glass obtained in the clarification step is continuously fed onto molten tin in a bath, and the molten glass is shaped by being fluidized on the molten tin, to thereby obtain a glass ribbon. In order to prevent oxidation of the molten tin, it is preferred that the atmosphere in the bath is composed of a mixed gas (reducing gas) of hydrogen gas and nitrogen gas. The proportion of the hydrogen gas occupied in the reducing gas is from 0.1 to 15 vol %. The temperature of the atmosphere in the bath is from 700 to 1250° C., and particularly the temperature at the upstream side is from 900 to 1250° C. The glass ribbon is cooled while being fluidized in a predetermined direction, and pulled up from the molten tin in the vicinity of an exit of the bath.

In the annealing step, the glass ribbon obtained in the forming step is annealed in an annealing furnace. The glass ribbon is annealed while being horizontally conveyed on rolls toward an exit of the annealing furnace from an inlet thereof. Sulfurous acid (SO₂) gas or the like is sprayed to the surface of the glass ribbon in the vicinity of the inside of the inlet of the annealing furnace, and a protective film is formed on a surface layer of the glass ribbon.

In the cutting step, the glass ribbon annealed in the annealing step is cut into a predetermined size by a cutting machine. In the cutting step, both edge parts (so-called margin part) in a width direction perpendicular to a flow direction of the glass ribbon are cut out.

In order to achieve the F content in the glass to be from 0.1 to 0.35 mass %, because F volatilizes in the melting step and clarification step, it is preferred to blend the glass raw materials such that the F content in the glass raw materials is from 0.15 to 1.0 mass %. The F content in the glass raw materials is preferably 0.25 mass % or more, and more preferably 0.35 mass % or more. It is also preferably 0.8 mass % or less, and more preferably 0.6 mass % or less.

In order to achieve the Cu content in the glass to be from 0.3 to 3 mass ppm, because Cu volatilizes in the melting step and clarification step, it is preferred to blend the glass raw materials such that the Cu content in the glass raw materials is from 0.4 to 6 mass ppm. The glass raw materials contain Cu as an unavoidable impurity. Therefore, the Cu content in the glass raw materials is preferably 0.5 mass ppm or more. It is also preferably 4 mass ppm or less, and more preferably 2 mass ppm or less.

In order to achieve the Cl content in the glass to be from 0 to 0.05 mass %, because Cl volatilizes in the melting step and clarification step, it is preferred to blend the glass raw materials such that the Cl content in the glass raw materials is 0.15 mass % or less. The Cl content in the glass raw materials is preferably 0.06 mass % or less, and more preferably 0.03 mass % or less.

In the present embodiment, in order to achieve the ratio f₁/f₂ to be from 0.05 to 0.5, the amount of F volatilized from the surface of the glass melt in the bath is controlled. The F volatilization amount in the bath is controlled by adjusting six forming conditions of: first, a temperature of a molten glass flown into the bath; second, a temperature distribution in a flow direction of the glass ribbon in the bath; third, a temperature distribution in a width direction perpendicular to the flow direction of the glass ribbon in the bath; fourth, a conveying speed of the glass ribbon on rolls in the annealing furnace; fifth, the amount of reducing gas to be introduced in and/or to be exhausted from the bath; and sixth, a hydrogen gas concentration in the reducing gas. Each condition is not only adjusted separately, but is minutely adjusted considering mutual relation. In order to achieve the cu₁/cu₂ to be from 0.05 to 0.7 and the ratio cl₁/cl₂ to be from 0.05 to 0.85, the Cu evaporation amount and Cl evaporation amount in the bath are controlled by adjusting the six forming conditions similarly as above.

### EXAMPLES

The present invention is described in detail below by reference to examples. However, the present invention is not construed as being limited to those.

### Reference Example

In this reference example, to simulate the phenomenon that Sn aggregates as an intermetallic compound between Cu and Sn being a nucleus in a bath, the following test was performed.

### Content of Experiment

To simulate the volatilization of Sn in a bath, compounds [(A) to (C)] that generate a gas containing Sn were placed on the bottom of an Al₂O₃-made vessel. Fine particles (Cu) that become nuclei when Sn aggregates were made adhering to a quartz substrate that becomes a lid of the Al₂O₃-made vessel. The vessel was rapidly heated (1100° C./2 minutes) in N₂ atmosphere to generate a gas containing Sn. After cooling the vessel, the lower surface of the quartz substrate was observed with an optical microscope, and the number of particles having a size of 5 μm or more in a visual filed of 500×300 was measured. The aggregate of Sn drops on the upper surface of a glass melt when grown to a size of about 10 μm. Therefore, the risk that a defect occurs on the top surface of a float sheet glass can be confirmed by measuring the number of particles having a size of 5 μm or more.

Condition 1: No compound

Condition 2: Compound (A) (SnCl₂)

Condition 3: Compound (B) (SnF₂)

Condition 4: Compound (C) (SnCl₂, SnF₂)

The condition 1 is the case that the state that Sn does not volatilize in a bath was simulated. The number of particles having a size of 5 μm or more is zero, and the risk that a defect occurs on the top surface of a float sheet glass is small.

The condition 2 is the case that the state that Sn and Cl₂ volatilize in a bath was simulated. The number of particles having a size of 5 μm or more is 10, and the risk that a defect occurs on the top surface of a float sheet glass is large.

The condition 3 is the case that the state that Sn and F₂ are volatilizing in a bath was simulated. The number of particles having a size of 5 μm or more is zero, and the risk that a defect occurs on the top surface of a float sheet glass is small.

The condition 4 is the case that the state that Sn, F₂ and Cl₂ volatilize in a bath was simulated. The number of particles having a size of 5 μm or more is 5, and the risk that a defect occurs on the top surface of a float sheet glass is large.

In this Example, profiles of F amount, Cu amount and Cl amount in a depth direction from the top surface of a float sheet glass were obtained by SIMS method. SIMS analysis conditions are as follows.

Equipment: IMS-7f manufactured by AMETEK

Primary ion species: Cs⁺

Accelerated voltage of primary ion: 15 kV

Detection region: 30 μm diameter

Polarity of secondary ion: Negative

Monitor secondary ion: ¹⁹F, ⁶³Cu, ³⁵Cl, ²⁸Si (or ³⁰Si)

Neutralization method: By Pt coating and electron beam irradiation to a sample surface

Reference sample for quantitative determination of concentration: Prepared every monitor secondary ion. Three in which ¹⁹F, ⁶³Cu or ³⁵Cl was ion-injected to thermal oxide film (SiO₂ film) on Si wafer, respectively.

This float sheet glass contains SiO₂: 61 mass %, Al₂O₃: 20 mass %, B₂O₃: 1 mass %, MgO: 6 mass %, CaO: 5 mass %, SrO: 7 mass %, and SnO₂: 0.2 mass % where MgO+CaO+SrO+BaO is 18 mass %, and contains F in an amount of 0.2 mass %, contains Cu in an amount of 0.5 mass ppm, and contains Cl in an amount of 0.01 mass %.

This float sheet glass has a glass transition point of 760° C., and T₄ of 1300° C.

In order to obtain this float sheet glass, glass raw materials were prepared such that F content is 0.4 mass %, Cu content is 0.6 mass ppm and Cl content is 0.2 mass % in the glass raw materials, and the glass raw materials were introduced into a melting furnace and melted, followed by clarification, to thereby obtain a molten glass.

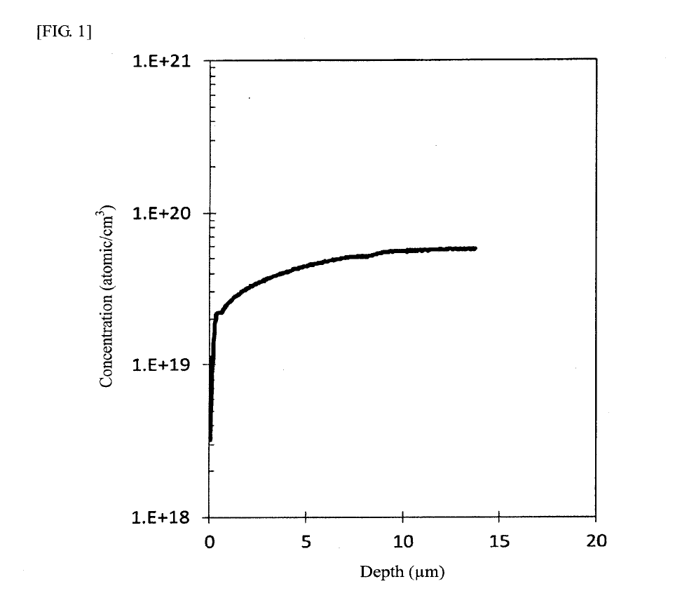

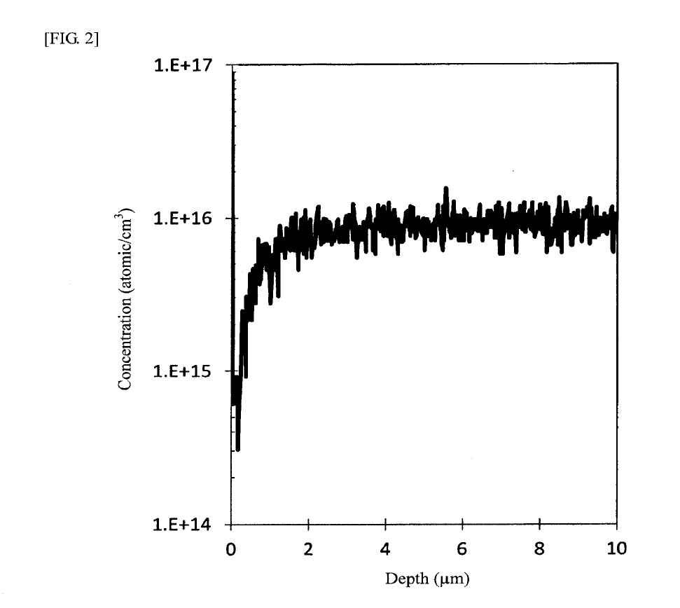

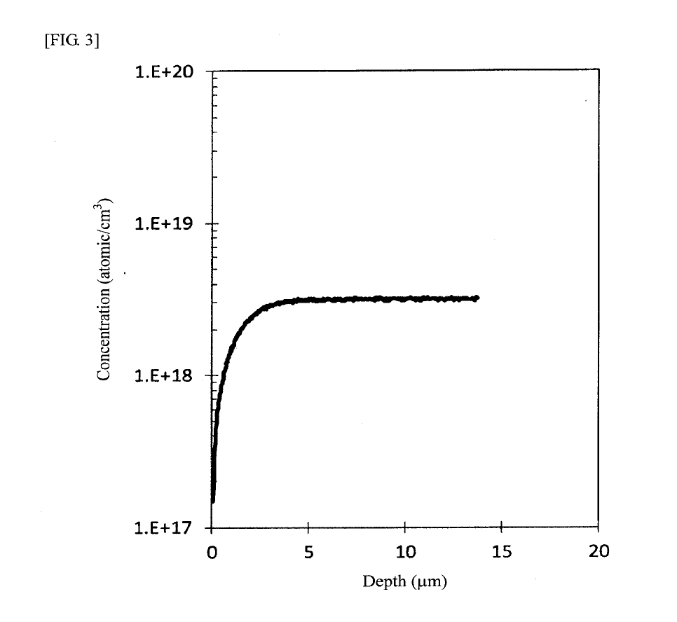

FIG. 1 is a view showing a profile of F amount in a depth direction from the top surface of the float sheet glass. FIG. 2 is a view showing a profile of Cu amount in a depth direction from the top surface of the float sheet glass. FIG. 3 is a view showing a profile of Cl amount in a depth direction from the top surface of the float sheet glass.

From FIG. 1, it can be confirmed that the ratio f₁/f₂ between the F amount f₁ at a depth of 1 μm from the top surface of the float sheet glass and the F amount f₂ at a depth of 13 μm from the top surface of the float sheet glass is 0.44, which satisfies from 0.05 to 0.5.

In order to achieve the ratio f₁/f₂ of 0.44, six forming conditions of: first, a temperature of the molten glass flown into the bath; second, a temperature distribution in a flow direction of the glass ribbon in the bath; third, a temperature distribution in a width direction perpendicular to the flow direction of the glass ribbon in the bath; fourth, a conveying speed of the glass ribbon on rolls in the annealing furnace; fifth, the amount of reducing gas to be introduced and/or to be exhausted from the bath; and sixth, a hydrogen gas concentration in the reducing gas were adjusted. Each condition was not only adjusted separately, but was minutely adjusted considering mutual relation, and formation was performed. Thus, a float sheet glass having the ratio f₁/f₂ of 0.44 was obtained.

From FIG. 2, it can be confirmed that the ratio cu₁/cu₂ between the Cu amount cu₁ at a depth of 0.5 μm from the top surface of the float sheet glass and the Cu amount cu₂ at a depth of 8 μm from the top surface of the float sheet glass is 0.33, which satisfies from 0.05 to 0.7.

The above six forming conditions were adjusted, and formation was performed. Thus, a float sheet glass having the ratio cu₁/cu₂ of 0.33 was obtained.

From FIG. 3, it can be confirmed that the ratio cl₁/cl₂ between the Cl amount cl₁ at a depth of 1 μm from the top surface of the float sheet glass and the Cl amount cl₂ at a depth of 13 μm from the top surface of the float sheet glass is 0.47, which satisfies from 0.05 to 0.85.

The above six forming conditions were adjusted, and formation was performed. Thus, a float sheet glass having the ratio cl₁/cl₂ of 0.47 was obtained.

Although the present invention has been described in detail and by reference to the specific embodiments, it is apparent to one skilled in the art that various modifications or changes can be made without departing the spirit and scope of the present invention.

This application is based on Japanese Patent Application (No. 2014-105192) filed on May 21, 2014, the disclosure of which is incorporated herein by reference in its entity.

1. An alkali-free float sheet glass having a glass transition point of from 730 to 850° C. and a temperature T₄ at which viscosity η reaches 10⁴ poises of from 1220 to 1350° C., and comprising, indicated by mass % on the basis of oxides:
SiO₂: 57 to 65%,
Al₂O₃: 14 to 23%,
B₂O₃: 0 to 5.5%,
MgO: 1 to 8.5%,
CaO: 3 to 12%,
SrO: 0 to 10%, and
BaO: 0 to 5%,
satisfying MgO+CaO+SrO+BaO of from 12 to 23%,
comprising F in an amount of from 0.1 to 0.35 mass %, comprising Cu in an amount of from 0.3 to 3 mass ppm, and comprising Cl in an amount of from 0 to 0.05 mass %, and
satisfying a ratio f₁/f₂ of from 0.05 to 0.5 between F amount f₁ in a region at a depth of 1 μm from a top surface of a float sheet glass and F amount f₂ at a depth of 13 μm from the top surface of the float sheet glass.

2. The alkali-free float sheet glass according to claim 1, further comprising SnO₂ in an amount of from 0.01 to 1 mass %.

3. The alkali-free float sheet glass according to claim 1, satisfying a ratio cu₁/cu₂ of from 0.05 to 0.7 between Cu amount cu₁ at a depth of 0.5 μm from the top surface of the float sheet glass and Cu amount cu₂ at a depth of 8 μm from the top surface of the float sheet glass.

4. The alkali-free float sheet glass according to claim 1, satisfying a ratio cl₁/cl₂ of from 0.05 to 0.85 between Cl amount cl₁ at a depth of 1 μm from the top surface of the float sheet glass and Cl amount cl₂ at a depth of 13 μm from the top surface of the float sheet glass.

5. A method for producing an alkali-free float sheet glass,
wherein the alkali-free float sheet glass comprising, indicated by mass % on the basis of oxides, the following components, F in an amount of from 0.1 to 0.35 mass %, Cu in an amount of from 0.3 to 3 mass ppm, and Cl in an amount of from 0 to 0.05 mass %, and having a glass transition point of from 730 to 850° C. and a temperature T₄ at which viscosity η reaches 10⁴ poises of from 1220 to 1350° C.,
the method comprises steps of preparing a glass raw material such that F content is from 0.15 to 1.0 mass %, Cu content is from 0.4 to 6 mass ppm and Cl content is 0.15 mass % or less in the glass raw material, introducing the glass raw material into a melting furnace to melt, and clarifying to obtain a molten glass:
SiO₂: 57 to 65%,
Al₂O₃: 14 to 23%,
B₂O₃: 0 to 5.5%,
MgO: 1 to 8.5%,
CaO: 3 to 12%,
SrO: 0 to 10%,
BaO: 0 to 5%, and
MgO+CaO+SrO+BaO: 12 to 23%.
